(19) United States
(12) Patent Application Publication
(10) Pub. No.: US 2026/0175994 A1
(43) Pub. Date: Jun. 25, 2026

(54) INTEGRATED ENVIRONMENTAL CONTROL AND BATTERY THERMAL MANAGEMENT SYSTEM FOR ELECTRIC AIRCRAFT

(71) Applicant: Intergalactic Spaceworx, LLC, St. George, UT (US)

(72) Inventors: Tony Ho, Glastonbury, CT (US); Jeff Senkiw, Bluffton, SC (US)

(21) Appl. No.: 19/424,784

(22) Filed: Dec. 18, 2025

Related U.S. Application Data
(60) Provisional application No. 63/737,559, filed on Dec. 20, 2024.

(51) Int. Cl. B64D 33/08; B64D 13/06; B64D 13/08; B64D 27/34; B64D 27/357; H01M 10/625; H01M 10/6569; H01M 50/204

(52) U.S. Cl. CPC B64D 33/08; B64D 13/08; B64D 27/34; B64D 27/357; H01M 10/625; H01M 10/6569; H01M 50/204; B64D 2013/064; B64D 2013/0648; H01M 2220/20

(57) ABSTRACT

A battery thermal management system (BTMS) for an electric aircraft is disclosed herein. The BTMS includes an air compression portion providing a supply of fresh air, an environmental control heat exchange system coupled to the air compression portion to receive the supply of fresh air, and a BTMS pump portion supplying a BTMS coolant. An electrical storage system controls a temperature of the set of batteries by enabling the transfer of heat from the set of batteries to the BTMS coolant and the heat transferred from the set of batteries to the BTMS coolant passes to the environmental control heat exchange system.

### CROSS-REFERENCE TO RELATED APPLICATION(S)

This Application claims priority to and the benefit of U.S. Provisional Patent. No. 63/737,559, filed Dec. 20, 2024, the entirety of which is incorporated herein by reference.

### FIELD OF TECHNOLOGY

The disclosure relates to a battery thermal management system (BTMS) for an aircraft, or a battery thermal management system interconnected with an aircraft environmental control system (ECS) or other aircraft thermal or environmental control systems.

### BRIEF DESCRIPTION OF THE DRAWINGS

In order that the advantages of the subject matter may be more readily understood, a more particular description of the subject matter briefly described above will be rendered by reference to specific examples that are illustrated in the appended drawings. Understanding that these drawings, which are not necessarily drawn to scale, depict only certain examples of the subject matter and are not therefore to be considered to be limiting of its scope, the subject matter will be described and explained with additional specificity and detail through the use of the drawings, in which:

FIG. 1 is a schematic flow diagram of an aircraft having an integrated environmental control and battery thermal management system, according to one or more examples of the present disclosure;

FIG. 2 is a schematic flow diagram of a flight deck and cabin portion of the system of FIG. 1, according to one or more examples of the present disclosure;

FIG. 3 is a schematic flow diagram of a fresh air compression portion and environmental control heat exchange system of the system of FIG. 1, according to one or more examples of the present disclosure;

FIG. 4 is a schematic flow diagram of a battery thermal management pump portion of the system of FIG. 1, according to one or more examples of the present disclosure;

FIG. 5 is a schematic flow diagram of a vapor cycle portion of the system of FIG. 1, according to one or more examples of the present disclosure; and

FIG. 6 is a schematic flow diagram of an electrical energy storage portion of the system of FIG. 1, according to one or more examples of the present disclosure.

FIG. 7 is a schematic flow diagram illustrating the interconnected system of FIGS. 2-6, according to one or more examples of the present disclosure.

FIG. 8 is a schematic flow diagram of a coolant circuit for cooling a electrical energy storage system, according to one or more examples of the present disclosure.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Disclosed herein are examples of an aircraft and an integrated environmental control and battery thermal management system (BTMS) of the aircraft. An environmental control portion and a battery thermal management control portion of the system cooperate, interact, and share components with each other to provide a simplified, efficient, and lightweight method for controlling the environment and regulating the temperature of the batteries of an electric aircraft. The system leverages common components and optimization of shared/integrated tasks associated with environmental control and battery thermal management. For example, the environment control portion and a battery thermal management control portion of the system share the same vapor cycle system. Moreover, the cooperation, interaction, and component sharing of the system enables efficient thermal regulation of the batteries without relying on the engine bleed air of the aircraft.

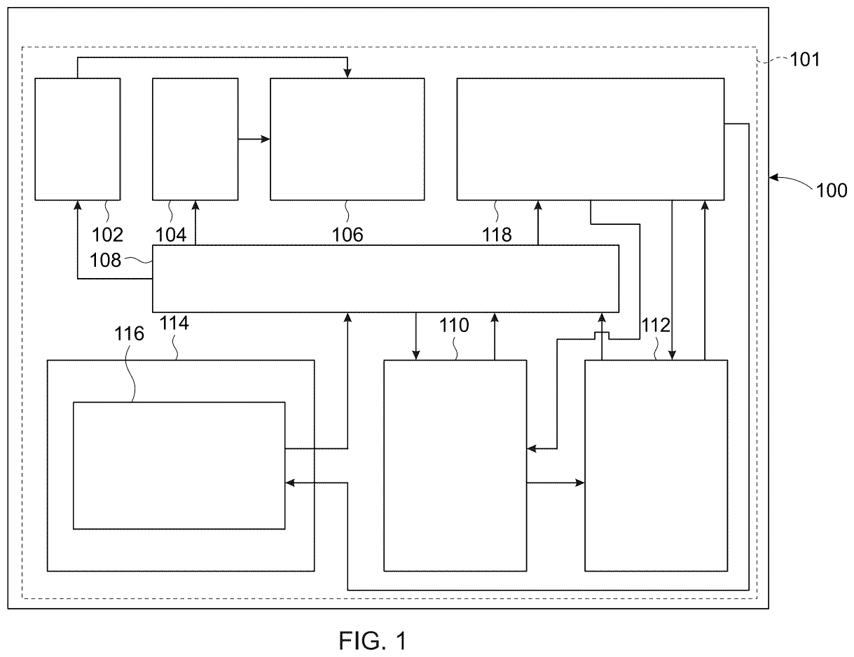

Referring to FIG. 1, according to some examples, an aircraft 100 includes an integrated environmental control and battery thermal management system 101 (hereinafter “the system 101”). The aircraft 100 can be any of various types of aircraft, including, but not limited to, regional and long-haul commercial aircraft. The system 101 includes an environmental control portion that shares a vapor cycle system 110 of the system 101 with a battery thermal management control portion of the system 101. The environmental control portion of the system 101 includes a flight deck evaporator system 102, a cabin evaporator system 104, a pressurization control system 106, an environmental control heat exchange system 108, and an air compression system 112. The battery thermal management control portion of the system 101 includes an electrical energy storage system 114 with a set of batteries 116, and a battery thermal management pump system 118.

The environmental control heat exchange system 108 is fluidically coupled with the vapor cycle system 110, which facilitates regulation of the temperature of fluids flowing through the environmental control portion of the system 101. Likewise, the battery thermal management pump system 118 is fluidically coupled with the vapor cycle system 110, which facilitates regulation of the temperature of fluids flowing through the battery thermal management control portion. The temperature of the fluids flowing through the environmental control portion is regulated to control the conditions (e.g., temperature, humidity, etc.) of air within the flight deck and cabin of the aircraft 100. Control of the pressure of the air within the flight deck and the cabin can be provided by the pressurization control system 106. The temperature of the fluids flowing through the battery thermal management control portion is regulated to control the temperature of the set of batteries 116 of the electrical energy storage system 114. Electrical energy stored in the set of batteries 116 is utilized for providing all the propulsion of the aircraft 100, when the aircraft is a fully electric aircraft, and at least some of the propulsion of the aircraft 100, when the aircraft is a hybrid/electric aircraft.

The air compression system 112 is fluidically coupled with the environmental control heat exchange system 108 and the battery thermal management pump system 118 to promote regulation of the temperature of the fluids flowing through environmental control portion and the battery thermal management control portion of the system 101. In some examples, the air compression system 112 receives fresh air from a location external to the aircraft 100, such as via a ram air inlet of the aircraft 100. The air compression system 112 also provides pressurization to the fuselage of the aircraft 100, such as the flight deck and/or cabin portions of the fuselage.

As used herein, the term “fluid” can be a liquid (e.g., refrigerant, coolant, etc.) or gas (e.g., air). It is also recognized that a fluid, as used herein, can include any of various other fluids, such as plasmas.

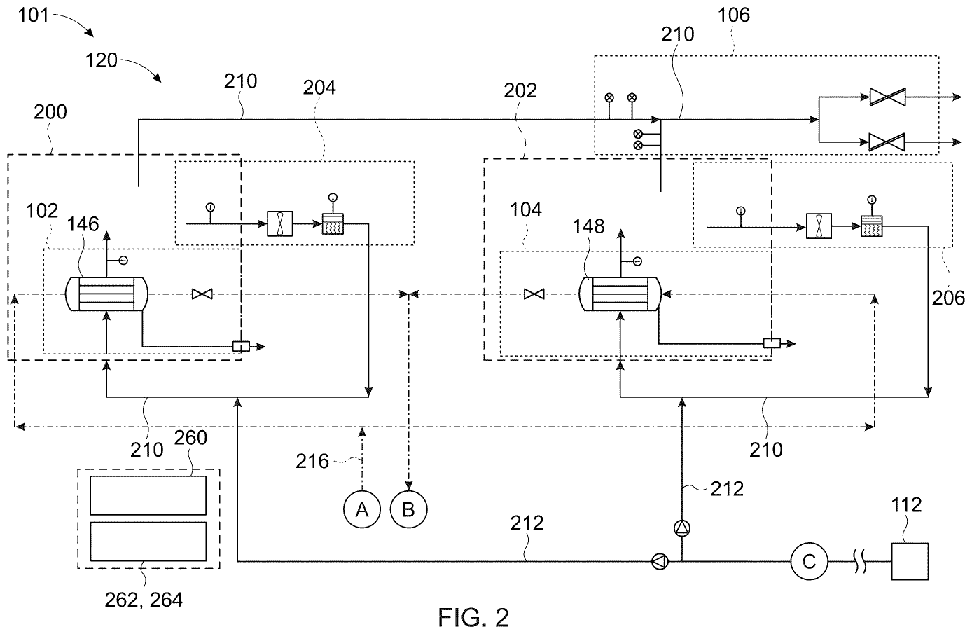

Referring to FIG. 2, a controlled environment portion 120 of the system 101 of FIG. 1 is shown. The controlled environment portion 120 includes a flight deck 200, a cabin 202 (e.g., a passenger cabin), or both a flight deck 200 and a cabin 202. When present, the flight deck 200 of the controlled environment portion 120 includes the flight deck evaporator system 102 and, when present, the cabin 202 of the controlled environment portion 120 includes the cabin evaporator system 104. The flight deck evaporator system 102 includes a flight deck evaporator 146 that is configured to receive a combination of recirculated air 210 from the flight deck 200 and fresh air 212, via air line C, from the air compression system 112, and to cool the air combination before introducing the air into the flight deck 200. Similarly, the cabin evaporator system 104 includes a cabin evaporator 148 that is configured to receive a combination of recirculated air 210 from the cabin 202 and fresh air 212 from the air compression system 112, and to cool the air combination before introducing the air into the cabin 202. In some examples, the controlled environment portion 120 further includes a flight deck fan assembly 204, configured to drive and heat the recirculated air 210 from the flight deck 200 before introducing it to the flight deck evaporator 146 of the flight deck evaporator system 102. Similarly, in certain examples, the controlled environment portion 120 includes a cabin fan assembly 206, configured to drive and heat the recirculated air from the cabin 202 before introducing it to the cabin evaporator 148 of the cabin evaporator system 104. The recirculated air 210 can exhaust from the flight deck 200 and the cabin 202 and pass to the pressurization control system 106.

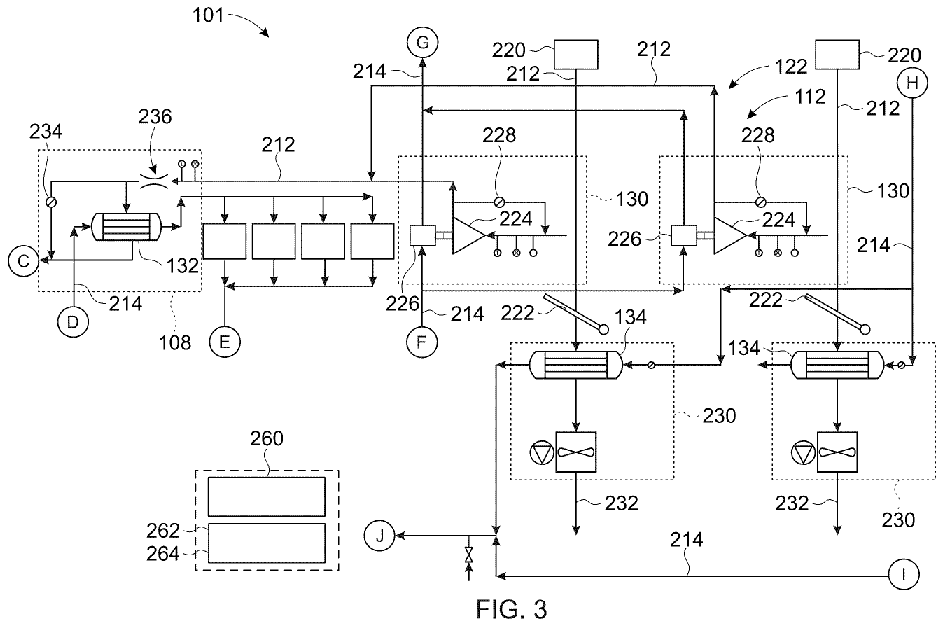

Referring to FIG. 3, an air compression portion 122 of the system 101 of FIG. 1 is shown. The air compression portion 122 includes the air compression system 112 and a portion of the environmental control heat exchange system 108. The air compression system 112 includes at least one ram air intake system 220. For symmetry and redundancy, in the illustrated example, the air compression system 112 includes two matching ram air intake systems 220. Each one of the ram air intake systems 220 includes a ram air inlet that is configured to receive fresh air 212 external to the aircraft 100. The fresh air 212 can be passively received as the aircraft 100 is in flight or actively received, such as via a ram air fan, when the aircraft 100 is not in flight or during low-speed flight conditions. Each one of the ram air intake systems 220 can further include a ram door 222 that helps regulate the flow rate of fresh air 212 through the ram air intake system 220. Additionally, each one of the ram air intake systems 220 includes an air compression assembly 130, such as a cabin air compression (CAC) assembly or a fresh air compression (FAC) assembly, which has an air compressor 224 and a motor 226 operably coupled to the air compressor 224. The motor operates 226 to rotate the air compressor 224, which draws at least a portion of the fresh air 212 received through the ram air inlet. The air compressor 224 is configured to compress the fresh air 212, which increases the pressure, which is necessary for pressurization of the flight deck 200 (FIG. 2) and the cabin 202 (FIG. 2), and temperature of the fresh air 212. In some examples, the air compression assembly 130 additionally includes a heat valve 228, which can be a recirculation valve, which is operable to regulate the flow rate of at least a portion of the compressed fresh air 212 into the fresh air upstream of the air compressor 224. The air compression assembly 130 may also include various sensors, such as temperature sensors, pressure sensors, and/or flow sensors, which sense the conditions of the fresh air prior to entering the air compressor 224. While the air compression system is described and illustrated as coupled to a ram air heat exchanger, it should be appreciated that a separate intake or scoop can be utilized to intake fresh air.

Each one of the ram air intake systems of the air compression portion 122 also includes a ram air heat exchanger assembly 230 that each includes a ram air heat exchanger 134 that receives the portion of the fresh air 212 not compressed by (e.g., bypassing) the air compressor 224. As will be explained in more detail below, the fresh air 212 passing through the ram air heat exchanger 134 is heated. After exiting the ram air heat exchanger 134, the heated ram air is expelled from the aircraft 100 via a ram air exit 232.

As shown in FIG. 3, the compressed fresh air from the air compression assembly 130 (or assemblies) is received by the environmental control heat exchange system 108, which includes a heat exchanger 132. The heat exchanger 132 receives at least a portion of the compressed fresh air 212 and regulates the temperature of (e.g., cools) the compressed fresh air. As explained in more detail below, the temperature of the compressed fresh air is cooled by a BTMS coolant 214 of the battery thermal management control portion of the system 101. Utilizing the BTMS coolant 214 to cool the compressed fresh air 212 improves system efficiency by reducing the heat required to be lifted by the flight deck evaporator 146 (FIG. 2) and the cabin evaporator 148 (FIG. 2). The environmental control heat exchange system 108 also includes a bypass valve 234, in some examples, which is operable to bypass at least a portion of the compressed fresh air 212 around the heat exchanger 132 when more heating is required or desired. The portion of the compressed fresh air 212 passing though the heat exchanger 132, and/or the portion of the compressed fresh air 212 bypassing the heat exchanger 132, is delivered to the controlled environment portion 120 (FIG. 2) of the system 101 via air line C. In certain examples, the environmental control heat exchange system 108 includes a flow sensor such as a hot wire anemometer or a Venturi 236 upstream of the heat exchanger 132. The venturi 236 measures air flow over a contraction using a measure pressure drop. The environmental control heat exchange system 108 can further include various sensors (e.g., temperature and flow rate sensors) upstream of the heat exchanger 132, which can help to control operation of the heat exchanger 132 and/or the bypass valve 234.

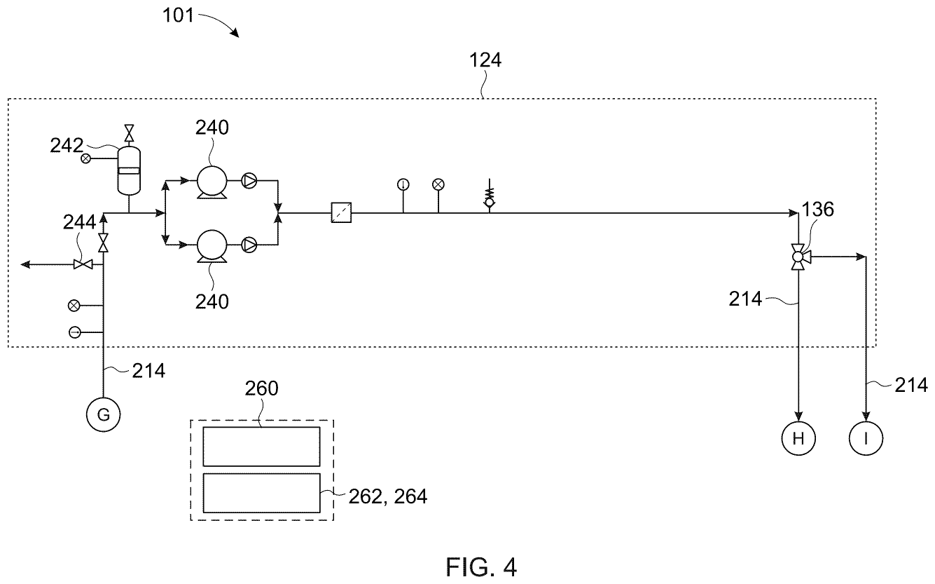

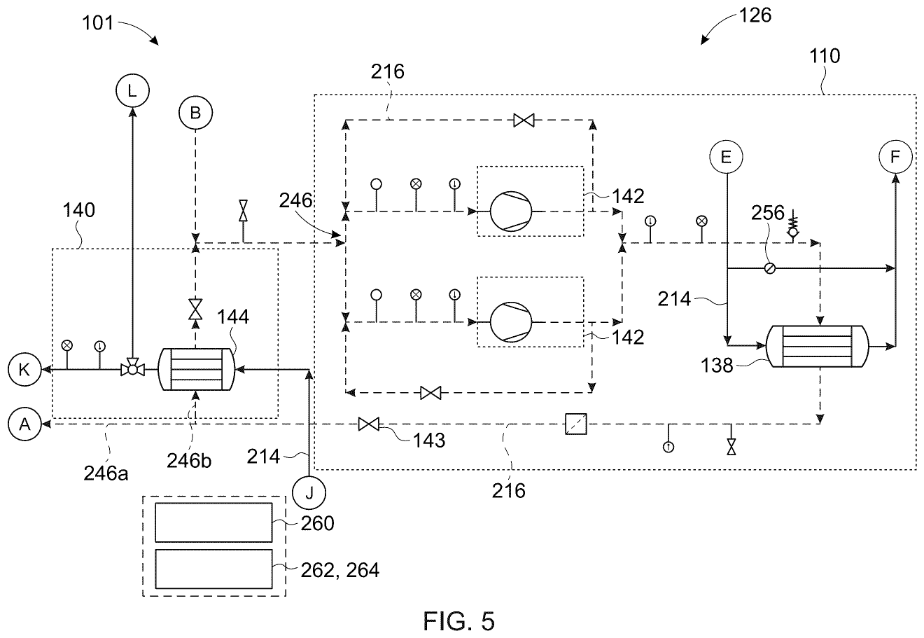

Referring to FIG. 4, the system 101 further includes a battery thermal management system (BTMS) pump portion 124, which includes one or more BTMS pumps 240. The BTMS pump portion 124 forms part of a battery thermal management system 101 of FIG. 1. The BTMS pumps 240 receive the BTMS coolant from line G. The BTMS pumps 240 are operable to drive BTMS coolant 214 through the battery thermal management portion or system of the system 101. The BTMS pump portion 124 pumps the BTMS coolant 214 through line H into the ram air heat exchangers 134 of the air compression portion 122 shown in FIG. 3. The ram air heat exchangers 134 (FIG. 3) facilitate the transfer of heat from the BTMS coolant 214 in line H into the ram air passing through the ram air heat exchangers 134, thus cooling the BTMS coolant in line H (see FIG. 3 also). The cooled BTMS coolant 214 is then delivered to a vapor cycle portion 126 (see FIG. 5) of the system 101, via line J (see FIG. 3), as will be explained in more detail in relation to FIG. 5. In some examples, the BTMS pump portion 124 includes a diverter valve 136 that is selectively operable to divert at least a portion of the BTMS coolant 214 pumped through the BTMS pumps 240 around the ram air heat exchangers 134 of the air compression portion 122 via line I. Referring briefly to FIG. 3, any diverted BTMS coolant 214 through line I is combined with the BTMS coolant 214 in line H, which passes through the ram air heat exchangers 134, to form the cooled BTMS coolant 214 in line J.

Referring again to FIG. 4, the BTMS pump portion 124 includes various other components to help facilitate efficient operation of the BTMS pumps 240. For example, the BTMS pump portion 124 can include an accumulator 242 upstream of the BTMS pumps 240, upstream refrigerant sensors upstream of the BTMS pumps 240, downstream refrigerant sensors downstream of the BTMS pumps 240, and a refrigerant purge port 244 to facilitate the release of old BTMS coolant 214 from the system 101.

Referring to FIG. 5, a vapor cycle portion 126 of the system 101 is shown. The vapor cycle portion 126 includes the vapor cycle system 110 (FIG. 1) and a battery thermal management chiller system 140. The vapor cycle portion 126 is configured, among other things, to regulate the characteristics of a vapor cycle system (VCS) refrigerant 216. The vapor cycle portion 126 is operable to execute a vapor-compression cycle of the VCS refrigerant 216. Accordingly, in one example, the vapor cycle portion 126 includes at least one compressor 142, a condenser 138, an expansion valve 143, the flight deck evaporator 146 (FIG. 2), the cabin evaporator 148 (FIG. 2), and a BTMS evaporator 144. In the illustrated example, the vapor cycle portion 126 includes two vapor-compression cycle (VCC) paths 246 for the VCS refrigerant 216.

A first VCC path 246a is defined by the two compressors 142 in parallel, the condenser 138, the expansion valve 143, and one or both of the flight deck evaporator 146 (FIG. 2) and the cabin evaporator 148 (FIG. 2). The vapor-compression cycle includes driving the VCS refrigerant 216 along the first VCC path 246a via operation of the compressors 142. The compressors 142 are powered by an electrical input and, when in operation, draw the VCS refrigerant 216 into one or both of the compressors 142 as a superheated vapor (i.e., cool low-pressure gas or low superheated vapor) and compresses the VCS refrigerant 216 so that the pressure of the superheated vapor substantially increases and the temperature of the superheated vapor substantially increases due to the heat of compression. The compressed vapor sheds heat to the BTMS coolant 214 as it passes through the condenser 138, which changes the state of the VCS refrigerant 216 from a superheated vapor to a saturated or sub-cooled liquid (i.e., warm high-pressure liquid). The saturated or sub-cooled liquid passes through the expansion valve 143, which changes the state of the VCS refrigerant 216 from the liquid state to a liquid-vapor mixture (i.e., cold low-pressure liquid-vapor mixture). The VCS refrigerant 216, as a liquid-vapor mixture, flows to the controlled environment portion 120 via line A, where it enters one or both of the flight deck evaporator 146 (FIG. 2) or the cabin evaporator 148 (FIG. 2). Turning briefly to FIG. 2, the liquid-vapor mixture receives heat from the recirculated air 210 (resulting in a cooling of the recirculated air 210) as it passes through the flight deck evaporator 146 and/or through the cabin evaporator 148, which changes the state of the liquid-vapor mixture to the superheated vapor. The VCS refrigerant 216, as a superheated vapor, flows back to the vapor cycle portion 126 via line B (returning again to FIG. 5), where it enters and is compressed by one or both of the compressors 142 to restart the vapor-compression cycle.

Still referring to FIG. 5, the second VCC path 246b is similar to the first VCC path 246a, except the flight deck evaporator 146 (FIG. 2) and the cabin evaporator 148 (FIG. 2) are effectively replaced by the BTMS evaporator 144. More specially, the second VCC path 246b is defined by the two compressors 142 in parallel, the condenser 138, the expansion valve 143, and the BTMS evaporator 144. However, unlike the first VCC path 246a, in the second VCC path 246b, after passing through the expansion valve 143, a portion of the VCS refrigerant 216 flows into the BTMS evaporator 144 instead of through the line A. After flowing through the BTMS evaporator 144, the portion of the VCS refrigerant 216 combines with the VCS refrigerant 216 from the conduit line B before the combined VCS refrigerant 216 is compressed by one or both of the compressors 142.

The vapor cycle portion 126 can include any of various additional components (e.g., pressure sensors, flow rate sensors, temperature sensors, filters, service valves, surge control valves, and the like) to help facilitate an efficient vapor-compression process.

Although shown and described as the vapor cycle portion 126 that regulates the temperature of the VCS refrigerant 216 via a vapor-compression cycle, in other examples, the vapor cycle portion 126 can be replaced with an Air Cycle System and the VCS refrigerant 216 can be replaced with air.

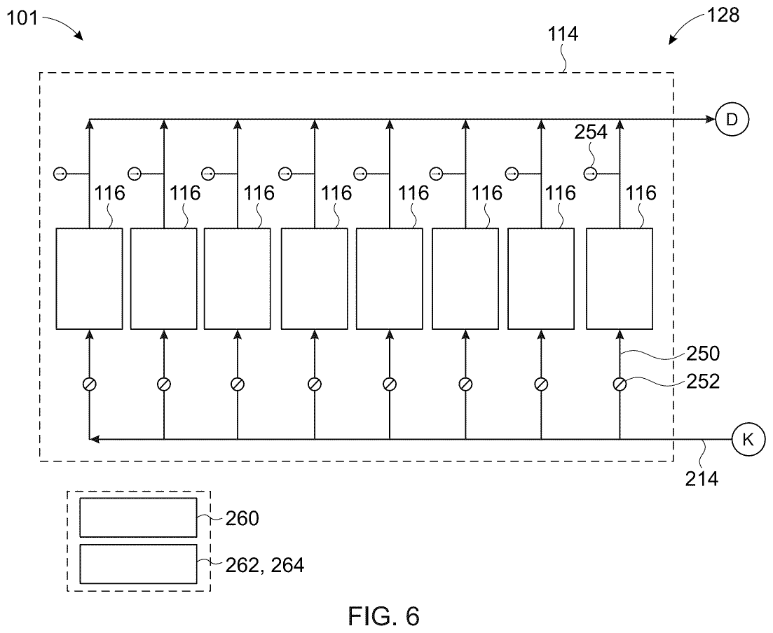

Referring to FIG. 6, an electrical energy storage portion 128 of the system 101 is shown. The electrical energy storage portion 128 includes the electrical energy storage system 114, which includes the set of batteries 116 or power backup units (PBUs). While the electrical energy storage portion 128 is described herein as a set of batteries 116, any energy storage system or device, or power source, is contemplated, including but not limited to fuel cells, hydrogen fuel cells, electric batteries, electrochemical cells, primary cells, or secondary cells. Heat exchange devices or systems disclosed herein can be used to cool or heat any type of electrical power source on the aircraft. Each one of the batteries 116 is configured to store electrical energy. In some examples, each battery 116 is capable of generating electrical energy greater than 100 kW. Moreover, each one of the batteries 116 is configured to receive the BTMS coolant 214 via a corresponding line 250. The flow rate of the BTMS coolant 214 through each one of the batteries 116 is regulated by a corresponding one of multiple valves 252 (e.g., a temperature control valve). As the BTMS coolant 214 flows through each battery 116, heat generated by the battery 116 is transferred to the BTMS coolant 214. The rate of heat transfer is dependent, at least partially, on the flow rate of the BTMS coolant 214 through the batteries 116. Accordingly, the rate of heat transfer, and thus the temperature of a battery 116, can be controlled by controlling the flow rate of BTMS coolant 214 through the battery 116 via the corresponding one of the valves 252. The flow rate can be based on the temperature of the BTMS coolant 214 exiting the batteries 116, which can be sensed by a corresponding one of multiple temperature sensors 254.

The BTMS coolant 214 entering the batteries 116 is received from the line K, which includes the BTMS coolant 214 exiting the BTMS evaporator 144 (FIG. 5). After flowing through the batteries 116, the BTMS coolant 214 enters line D.

Referring again to FIG. 3, the BTMS coolant 214 passes through the heat exchanger 132 of the environmental control heat exchange system 108. As the BTMS coolant 214 passes through the heat exchanger 132, heat from the fresh air 212, passing through the heat exchanger 132, is transferred to the BTMS coolant 214. The BTMS coolant 214, after passing through the heat exchanger 132, can collect heat from any of various mechanical or electrical components, such as microcontrollers configured to control various portions or systems of the system 101. After collecting heat from the components, the BTMS coolant 214 enters line E.

Referring again to FIG. 5, from line E, the BTMS coolant 214 enters the condenser 138 of the vapor cycle portion 126. In the condenser 138, heat is transferred between the BTMS coolant 214 and the VCS refrigerant 216 via a heat exchange process. The flow rate of the BTMS coolant 214 through the condenser 138 can be regulated via operation of a head pressure control valve 256, which, when open, acts to bypass at least a portion of the BTMS coolant 214 around the condenser 138 thus increasing the VCS condensing pressure. The BTMS coolant 214, whether bypassing or passing through the condenser 138, enters line F.

Referring again to FIG. 3, from line F, the BTMS coolant 214 passes through or along the motors driving the compressors of the air compression assemblies 130 of the air compression portion 122. After collecting heat from the motors, the BTMS coolant 214 enters line G, which, as shown in FIG. 4, is fluidically coupled with the BTMS pump portion 124.

Still referring to FIG. 3, the system 101 further includes one or more controllers, such as a CPCS controller 260, an ECS controller 262, and/or a BTMS controller 264, which control the corresponding portions of the system 101. The controllers 260, 262, 264, which can be separate controllers or a single controller, cooperate to regulate the temperature and flow rates of the VCS refrigerant 216, the BTMS coolant 214, and the fresh air 212 to efficiently maintain the temperature of the batteries 116, the cabin 202 (FIG. 2), the flight deck 200 (FIG. 2), and various other heat-generating or heat-requiring components of the system 101 within desirable levels. Efficiency is facilitated by sharing one or more heat exchanging components of the system 101. For example, heat is directly transferred between the BTMS coolant 214 and the VCS refrigerant 216 at the condenser 138 of the vapor cycle portion 126, to be effectively shared by the controlled environment portion 120 and the battery thermal management control portion of the system 101. Additionally, heat can be directly transferred between the BTMS coolant 214 and the VCS refrigerant 216 at the BTMS evaporator 144 of the vapor cycle portion 126, to be effectively shared by the controlled environment portion 120 and the battery thermal management control portion of the system 101.

The VCS refrigerant and the BTMS coolant can be any of various liquid refrigerants or coolants know in the art.

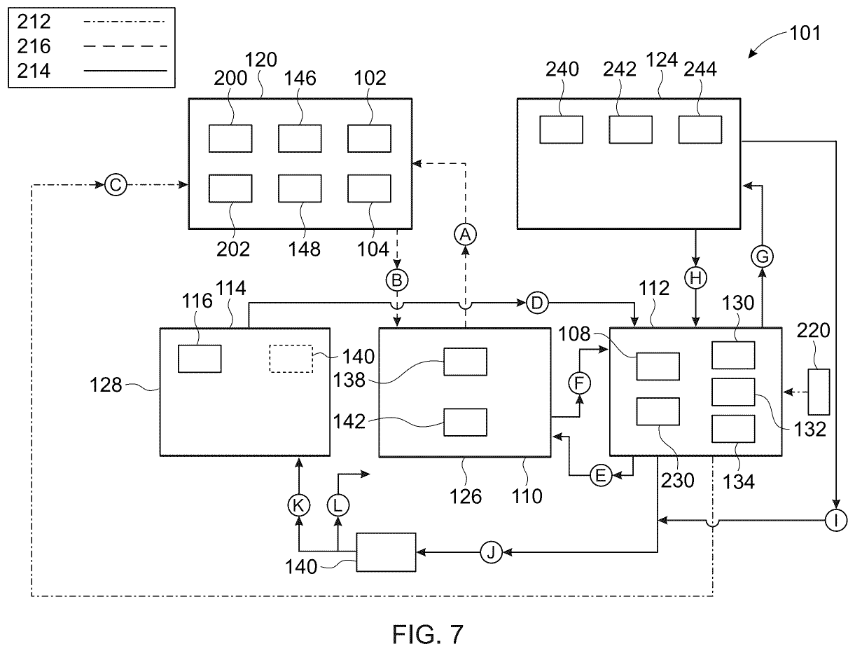

FIG. 7 shows a schematic flow chart illustrating the system 101 and its interconnected flows. Certain components or portions of the system 101 need relatively cooler fluids, for example, as compared to other components or portions of the system 101, or that heated or cooled portions of the system 101 can be utilized at certain portions or components of the system 101 to further heat or cool existing fluids within the system 101. Therefore, it is be beneficial to provide the relatively coolest temperature flow to the areas needing the coolest temperatures, and to provide the relatively hottest temperatures to areas that benefit the most from such temperatures. In particular, energy storage systems, like the electrical energy storage system 114, the batteries 116, and/or the electrical energy storage portion 128 can generate large amounts of heat, and therefore, can receive a greater benefit from relatively cooler temperatures as compared to other portions of the system 101.

The system 101 includes the air compression system 112 which can receive a flow of clean air or external air, shown as provided from the ram air intake system 220. The air compression system 112 can include the ram air heat exchanger assemblies 230, which utilize the ram air heat exchangers 134 to cool the BTMS coolant 214. Additionally, the air compression system 112 can include the air compression assembly 130, which utilizes the ram air from the ram air intake system 220 to provide fresh air to the flight deck 200 and the cabin 202. Furthermore, the air compression system 112 can include the environmental control heat exchange system 108 which utilizes the heat exchanger 132 to provide fresh air to the flight deck 200 and the cabin 202.

The system 101 includes the vapor cycle system 110 that has the compressors 142 arranged in parallel and configured to compress the VCS refrigerant 216. The compressed VCS refrigerant 216 is used to cool the BTMS coolant 214 at the condenser 138 (FIG. 5).

The system 101 further includes the electrical energy storage system 114 that can include the set of batteries 116. The electrical energy storage system 114 can include the battery thermal management chiller system 140, while it is contemplated that the battery thermal management chiller system 140 is not a portion of the electrical energy storage system 114, and a portion of the larger system 101 interconnected with the electrical energy storage system 114.

The system further includes the controlled environment portion 120 that can include the flight deck 200 and cabin 202. The controlled environment portion 120 receives the fresh air 212 from the air compression system 112, which can utilize the fresh air 212 taken at the ram air intake system 220.

The system 101 further includes the air compression portion 122. The air compression portion 122 receives the BTMS coolant 214 from the air compression system 112 (FIG. 3).

The fresh air 212 taken at the ram air intake system 220 can be the relatively coldest air compared to the air within the system 101, or even the BTMS or VCS coolants or refrigerants 214, 216, while it is contemplated that other fluids or coolants may be cooler. For example, higher altitude operation would utilize much colder air than air at lower altitudes. The fresh air 212 taken at the ram air intake system 220 is utilized at the air compression system 112 to cool the BTMS coolant 214. Utilizing the fresh air 212 taken from the ram air intake system 220 utilizes the relatively coolest air to cool the BTMS coolant 214, reducing the temperature of the BTMS coolant 214 relative to the temperature of the fresh air 212. The cooled BTMS coolant 214 is then provided, via line J, to the battery thermal management chiller system 140. In this way, the battery thermal management chiller system 140 receives the BTMS coolant 214 that has already been cooled from the fresh air 212. The battery thermal management chiller system 140 then provides the BTMS coolant 214 to the electrical energy storage system 114 to cool the batteries 116. The heat taken from the batteries 116 at the electrical energy storage system 114 can then be utilized to heat additional portions of the system 101. For example, the VCS refrigerant 216 provided to the controlled environment portion 120 can be heated this way, or, can even be further cooled depending on the differences in temperatures, which can provide heated or cooled VCS refrigerant 216 to the cabin 202 or flight deck 200.

In this way, it should be understood that the system 101 can prioritize portions of the system based upon need. In one example, the coolest temperatures within the system 101 are provided to cool the BTMS coolant first, in order to provide cold BTMS coolant to the electrical energy storage system 114, where the batteries 116 can receive the greatest benefit from the coldest temperatures.

Providing the coldest temperatures to the electrical energy storage system 114 provides for relatively greater heat dissipation, which can facilitate the usage of electrical energy systems within aircraft 100 (FIG. 1). This increases overall efficiency of the system 101, as well as utilizes the heat generated from the batteries 116 or the electrical energy storage system 114 to heat other portions of the system 101, such as the flight deck 200 or the cabin 202, in non-limiting examples.

Such heat management of the system 101 and the electrical energy storage system 114 further facilitates the use of electrical storage on aircraft or turbine systems, which is beneficial in reducing emissions as such electrical power does not emit the same emissions as traditional fuels, like Jet-A, in a non-limiting example.

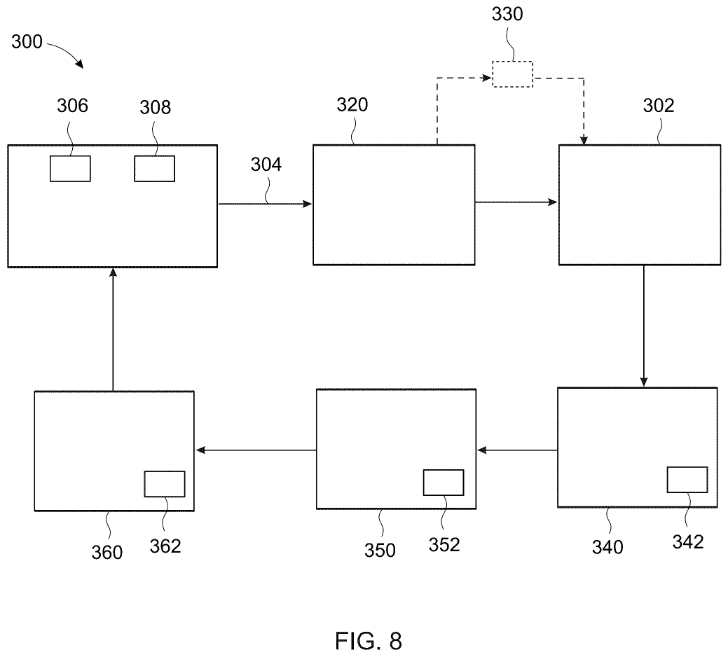

Referring to FIG. 8, a coolant circuit 300 for cooling an electrical energy storage system (EESS) 302 with a coolant 304. The coolant circuit 300 includes a coolant reservoir 306, such as a coolant accumulator in a non-limiting example. A coolant pump assembly 308 can provide for pumping a coolant from the coolant reservoir 306 along the coolant circuit 300.

The coolant 304 is provided to a ram air heat exchange assembly 320. A ram air cools the coolant 304 within the ram air heat exchange assembly 320. The coolant 304 passes from the ram air heat exchange assembly 320 to the EESS 302 to cool the EESS 302. Optionally, prior to passing to the EESS 302, the coolant 304 can pass to a chiller assembly 330. The chiller assembly 330 can further cool the coolant 304 prior to passing to the EESS 302. The chiller assembly 330 can utilize a refrigerant, such as a VCS refrigerant from a vapor cycle system, like the VCS refrigerant 216 and the vapor cycle system 110 discussed in FIG. 5 in a non-limiting example.

The coolant 304 cools the EESS 302 via heat transfer from the EESS 302 to the coolant 304. The coolant 304 when passing to the EESS 302 is at its lowest temperature, or greatest cooling capacity, when passing to the EESS 302. The coolant 304 is at its greatest cooling capacity due to cooling from the ram air heat exchange assembly 320 and the optional chiller assembly 330. This provides for the greatest amount of heat transfer from the EESS 302 to the coolant 304, thereby maximizing cooling of the EESS 302.

From the EESS 302, the coolant 304 (carrying the heat from the EESS 302) passes to an environmental control system heat exchanger assembly (ECS HX assembly) 340. The ECS HX assembly 340 can include an ECS heat exchanger 342 that extracts heat from the coolant 304 to heat a portion of ram air, and further cool the coolant 304 after cooling the EESS 302.

From the ECS HX assembly 340 the coolant 304 can be provided to a controller assembly 350. The controller assembly 350 can include a set of controllers 352, such as motor controllers or electrical controllers for the coolant circuit 300, other circuits, such as a ram air or VCS refrigerant circuit, or portions thereof. For example, the set of controllers 352 can be a motor controller for a cabin air compressor compressing the ram air or a ram air fan in non-limiting examples. The controller assembly 350 has the next greatest cooling need, second to the EESS 302. Therefore, the coolant 304 is provided to the controller assembly 350 after the EESS 302 in order to maximize cooling capacity of the coolant 304 along the coolant circuit 300.

From the controller assembly 350, the coolant 304 can pass to a vapor cooling system (VCS) 360 with a VCS condenser 362 within to further cool the coolant 304. The coolant 304 can then pass to a motor 364 for a cabin air compressor 366 that compresses the ram air. Thereafter, the coolant 304 returns to the coolant reservoir 306 to complete the coolant circuit 300.

The coolant circuit 300 provides the coolant 304 to the EESS 302 at a maximum cooling capacity, as the EESS 302 requires the greatest amount of cooling along the coolant circuit 300. After the EESS 302, the coolant 304 passes to the controller assembly 350, which requires the next-greatest amount of cooling after the EESS 302. This arrangement utilizes the cooling capacity of the coolant 304 at its greatest cooling capacity to transfer heat from the EESS 302.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all the items are mutually exclusive and/or mutually inclusive, unless expressly specified otherwise. The terms “a,” “an,” and “the” also refer to “one or more” unless expressly specified otherwise. Further, the term “plurality” can be defined as “at least two.” Moreover, unless otherwise noted, as defined herein a plurality of particular features does not necessarily mean every particular feature of an entire set or class of the particular features.

The term “about” or “substantially” or “approximately” in some embodiments, is defined to mean within +/−5% of a given value, however in additional embodiments any disclosure of “about” or “substantially” or “approximately” may be further narrowed and claimed to mean within +/−4% of a given value, within +/−3% of a given value, within +/−2% of a given value, within +/−1% of a given value, or the exact given value. Further, when at least two values of a variable are disclosed, such disclosure is specifically intended to include the range between the two values regardless of whether they are disclosed with respect to separate embodiments or examples, and specifically intended to include the range of at least the smaller of the two values and/or no more than the larger of the two values. Additionally, when at least three values of a variable are disclosed, such disclosure is specifically intended to include the range between any two of the values regardless of whether they are disclosed with respect to separate embodiments or examples, and specifically intended to include the range of at least the A value and/or no more than the B value, where A may be any of the disclosed values other than the largest disclosed value, and B may be any of the disclosed values other than the smallest disclosed value.

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent to another element without being in contact with that element.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagram(s), if included herein, is generally set forth as a logical flow chart diagram. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

To the extent not already described, the different features and structures of the various embodiments can be used in combination, or in substitution with each other as desired. That one feature is not illustrated in all of the embodiments is not meant to be construed that it cannot be so illustrated, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A battery thermal management system (BTMS) for an electric aircraft, the BTMS comprising: an air compression portion providing a supply of fresh air; an environmental control heat exchange system coupled to the air compression portion to receive the supply of fresh air; a BTMS pump portion supplying a BTMS coolant; an electrical storage system comprising a set of batteries, wherein the electrical storage system is configured to control a temperature of the set of batteries by enabling a transfer of heat from the set of batteries to the BTMS coolant; and wherein the heat transferred from the set of batteries to the BTMS coolant passes to the environmental control heat exchange system to provide heat to the fresh air.

The BTMS of any preceding clause, wherein the environmental control heat exchange system includes a heat exchanger providing heat from the BTMS coolant to the fresh air.

The BTMS of any preceding clause, wherein the air compression portion comprises a ram air intake system receiving the supply of fresh air.

The BTMS of any preceding clause, wherein the ram air intake system includes at least one ram air heat exchanger assembly.

The BTMS of any preceding clause, wherein the at least one ram air heat exchanger assembly includes a ram air heat exchanger configured to provide heat from the BTMS coolant to the fresh air prior to provision of the BTMS coolant to the set of batteries.

The BTMS of any preceding clause, further comprising a BTMS pump portion providing the BTMS coolant to the air compression portion.

The BTMS of any preceding clause, wherein the BTMS pump portion includes an accumulator to store the BTMS coolant.

The BTMS of any preceding clause, further comprising a vapor cycle system receiving the BTMS coolant from the air compression portion.

The BTMS of any preceding clause, wherein the vapor cycle system comprises a vapor cycle portion including a BTMS evaporator configured to transfer heat between the BTMS coolant and a VCS refrigerant.

The BTMS of any preceding clause, further comprising a controlled environment portion coupled to the environmental control heat exchange system; wherein the controlled environment portion comprises at least one of a flight deck evaporator or a cabin evaporator; and wherein the fresh air heated by the BTMS coolant passes to the controlled environment portion.

The BTMS of any preceding clause, wherein the controlled environment portion includes both the flight deck evaporator and the cabin evaporator.

The BTMS of any preceding clause, wherein the fresh air heated by the BTMS coolant is provided to a supply of recirculated air passing within the at least one of the flight deck evaporator or the cabin evaporator.

An electric aircraft comprising: a battery thermal management system configured to manage a temperature of an electrical storage system, the battery thermal management system comprising: an air compression portion providing a supply of fresh air; an environmental control heat exchange system coupled to the air compression portion to receive the supply of fresh air; a BTMS pump portion supplying a BTMS coolant; a set of batteries provided in the electrical storage system, wherein the electrical storage system is configured to control the temperature of the set of batteries by enabling a transfer of heat from the set of batteries to the BTMS coolant; and wherein the heat transferred from the set of batteries to the BTMS coolant passes to the environmental control heat exchange system to provide heat to the fresh air.

The electric aircraft of any preceding clause, wherein the environmental control heat exchange system includes a heat exchanger providing heat from the BTMS coolant to the fresh air.

The electric aircraft of any preceding clause, wherein the air compression portion comprises a ram air intake system receiving the supply of fresh air.

The electric aircraft of any preceding clause, wherein the ram air intake system includes at least one ram air heat exchanger assembly that includes a ram air heat exchanger configured to provide heat from the BTMS coolant to the fresh air prior to provision of the BTMS coolant to the set of batteries.

The electric aircraft of any preceding clause, further comprising a BTMS pump portion providing the BTMS coolant to the air compression portion.

The electric aircraft of any preceding clause, wherein the BTMS pump portion includes an accumulator to store the BTMS coolant.

The electric aircraft of any preceding clause, further comprising a vapor cycle system receiving the BTMS coolant from the air compression portion, wherein the vapor cycle system comprises a vapor cycle portion including a BTMS evaporator configured to transfer heat between the BTMS coolant and a VCS refrigerant.

The electric aircraft of any preceding clause, further comprising a controlled environment portion coupled to the environmental control heat exchange system; wherein the controlled environment portion comprises at least one of a flight deck evaporator or a cabin evaporator; and wherein the fresh air heated by the BTMS coolant passes to the controlled environment portion.

What is claimed is:

1. A battery thermal management system (BTMS) for an electric aircraft, the BTMS comprising:
an air compression portion providing a supply of fresh air;
an environmental control heat exchange system coupled to the air compression portion to receive the supply of fresh air;
a BTMS pump portion supplying a BTMS coolant;
an electrical storage system comprising a set of batteries, wherein the electrical storage system is configured to control a temperature of the set of batteries by enabling a transfer of heat from the set of batteries to the BTMS coolant; and
wherein the heat transferred from the set of batteries to the BTMS coolant passes to the environmental control heat exchange system to provide heat to the fresh air.

2. The BTMS of claim 1, wherein the environmental control heat exchange system includes a heat exchanger providing heat from the BTMS coolant to the fresh air.

3. The BTMS of claim 1, wherein the air compression portion comprises a ram air intake system receiving the supply of fresh air.

4. The BTMS of claim 3, wherein the ram air intake system includes at least one ram air heat exchanger assembly.

5. The BTMS of claim 4, wherein the at least one ram air heat exchanger assembly includes a ram air heat exchanger configured to provide heat from the BTMS coolant to the fresh air prior to provision of the BTMS coolant to the set of batteries.

6. The BTMS of claim 1, further comprising a BTMS pump portion providing the BTMS coolant to the air compression portion.

7. The BTMS of claim 6, wherein the BTMS pump portion includes an accumulator to store the BTMS coolant.

8. The BTMS of claim 1, further comprising a vapor cycle system receiving the BTMS coolant from the air compression portion.

9. The BTMS of claim 8, wherein the vapor cycle system comprises a vapor cycle portion including a BTMS evaporator configured to transfer heat between the BTMS coolant and a VCS refrigerant.

10. The BTMS of claim 1, further comprising a controlled environment portion coupled to the environmental control heat exchange system;
wherein the controlled environment portion comprises at least one of a flight deck evaporator or a cabin evaporator; and
wherein the fresh air heated by the BTMS coolant passes to the controlled environment portion.

11. The BTMS of claim 10, wherein the controlled environment portion includes both the flight deck evaporator and the cabin evaporator.

12. The BTMS of claim 10, wherein the fresh air heated by the BTMS coolant is provided to a supply of recirculated air passing within the at least one of the flight deck evaporator or the cabin evaporator.

13. An electric aircraft comprising:
a battery thermal management system configured to manage a temperature of an electrical storage system, the battery thermal management system comprising:
an air compression portion providing a supply of fresh air;
an environmental control heat exchange system coupled to the air compression portion to receive the supply of fresh air;
a BTMS pump portion supplying a BTMS coolant;
a set of batteries provided in the electrical storage system, wherein the electrical storage system is configured to control the temperature of the set of batteries by enabling a transfer of heat from the set of batteries to the BTMS coolant; and
wherein the heat transferred from the set of batteries to the BTMS coolant passes to the environmental control heat exchange system to provide heat to the fresh air.

14. The electric aircraft of claim 13, wherein the environmental control heat exchange system includes a heat exchanger providing heat from the BTMS coolant to the fresh air.

15. The electric aircraft of claim 13, wherein the air compression portion comprises a ram air intake system receiving the supply of fresh air.

16. The electric aircraft of claim 15, wherein the ram air intake system includes at least one ram air heat exchanger assembly that includes a ram air heat exchanger configured to provide heat from the BTMS coolant to the fresh air prior to provision of the BTMS coolant to the set of batteries.

17. The electric aircraft of claim 1, further comprising a BTMS pump portion providing the BTMS coolant to the air compression portion.

18. The electric aircraft of claim 17, wherein the BTMS pump portion includes an accumulator to store the BTMS coolant.

19. The electric aircraft of claim 13, further comprising a vapor cycle system receiving the BTMS coolant from the air compression portion, wherein the vapor cycle system comprises a vapor cycle portion including a BTMS evaporator configured to transfer heat between the BTMS coolant and a VCS refrigerant.

20. The electric aircraft of claim 13, further comprising a controlled environment portion coupled to the environmental control heat exchange system;
wherein the controlled environment portion comprises at least one of a flight deck evaporator or a cabin evaporator; and
wherein the fresh air heated by the BTMS coolant passes to the controlled environment portion.
